(19) United States
(12) Patent Application Publication
(10) Pub. No.: US 2023/0143316 A1
(43) Pub. Date: May 11, 2023

(54) WASTE CONTAINER

(71) Applicant: Embalajes Capsa, S.L., Canet De Mar (ES)

(72) Inventors: Manuel LÓPEZ MASAGUÉ, Canet De Mar (ES); Laura Carmen LÓPEZ CRESPO, Canet De Mar (ES)

(21) Appl. No.: 18/093,925

(22) Filed: Jan. 6, 2023

Related U.S. Application Data
(63) Continuation of application No. PCT/EP2021/067818, filed on Jun. 29, 2021.

(30) Foreign Application Priority Data
Jul. 7, 2020 (EP) 20382608.6

(51) Int. Cl. B65F 1/14; B65F 1/06

(52) U.S. Cl. CPC B65F 1/1426; B65F 1/06; B65F 2001/1653

(57) ABSTRACT

A waste container comprises a foldable sheet provided with a plurality of folding lines, which, when folded to define the waste container, comprises: a bottom; side walls, including a first side wall and a second side wall; a lid; and a first holding element to hold a bag. The waste container defines an inlet mouth arranged on the first side wall for introduction of waste into the waste container.

### CROSS REFERENCE TO RELATED APPLICATIONS

This application is a continuation of International Application No. PCT/EP2021/067818, filed on Jun. 29, 2021, which claims priority under 35 U.S.C. §119(a)-(d) to Application No. EP 20382608.6 filed on Jul. 7, 2020, the entire contents of which are hereby incorporated by reference.

### TECHNICAL FIELD

The present disclosure relates to a waste container that defines an entry opening for the introduction of waste into the container.

### BACKGROUND

The use of waste containers is common in offices and in homes, which are formed from a rigid material, for example plastic, which define a body provided with an entrance opening for the introduction of waste. These wastes include paper, packaging, and food, among others.

Due to the need to recycle and classify waste from the source, the joint use of several containers is normal, which represents a drawback due to the space they occupy. This drawback is especially important in private homes.

Another drawback of traditional waste containers is that, being usually made of plastic, they are not disposable and require periodic cleaning, which can be uncomfortable for users.

Therefore, an objective of the present disclosure is to provide a waste container that occupies a reduced space, practically nil in the event that it is not used, and that can be stacked.

Furthermore, another objective of the present disclosure is to provide a waste container whose cost is very low, and, for this reason, the user can discard it after one or a few uses. For this reason, it would be desirable for the container to be made of an easy-to-recycle and environmentally friendly material.

There are some previous disposable waste containers or designed for short periods of use made of cardboard. In most cases they are cardboard containers with four or more side walls, fully open at the top, which incorporate a perforated lid.

In this way, they can house a bag that is attached to the container by folding the end of the bag around the edge of the container and then securing it with the lid. This design, having the opening at the top, has the disadvantage of not being stackable, so it takes up a lot of space in the event that several containers are needed, for example, for the separation of waste for recycling.

In the case of making a hole in one of the side walls to be able to introduce the waste in two or more stacked boxes, it would not be possible to house them inside a bag, since the only way to fix it would be to fold the end of the bag by the upper edge of the container so that if one introduces the waste through a hole located in a side wall, it would fall out of the bag.

Another drawback of these models is that two pieces of cardboard are necessary for each container unit, so the material consumption is higher. The fact that each container is made up of two elements favors distribution and storage problems. The two parts could be separated for example at the point of sale, one of them being lost and therefore being unusable. In addition, it hinders the individual sale of the container that needs a packaging that groups the two elements.

### SUMMARY

With the disclosed waste container, the disadvantages of prior containers are solved, presenting other advantages that will be described below.

The waste container according to the present disclosure comprises a bottom, side walls and a lid, and is provided with an inlet mouth for the introduction of waste, which is formed from a sheet provided with a plurality of folding lines defining the bottom, the side walls and the lid, the inlet mouth being arranged on one of the side walls, and comprising a first holding element for holding a bag.

Advantageously, the first holding element is arranged on a different side wall from the side wall where the inlet mouth is arranged, for example, the first holding element is arranged on the side wall opposite to the side wall where the inlet mouth is arranged, and it can be arranged at a height equal to or greater than the height of the lower edge of the inlet mouth.

This holding element that does not exist in other disposable waste containers on the market is the one that allows a disposable material waste container to hold garbage bags and also have an inlet opening on a side wall instead of the usual ones that are at the top, and in this way one can choose to stack several containers together.

Furthermore, in most cases, existing bins will fit the bag by placing it around the waste inlet, which is usually at the top of the container.

The location of the holding element(s) in the waste container according to the present disclosure is preferably above or at the same level as the lower edge of the inlet mouth. This prevents debris from accidentally spilling over the edges of the bag as it is inserted.

When the holding element is located on the side wall opposite the inlet mouth, the natural opening of the bag is towards the mouth, facilitating the filling of the bag.

When there is also a second fastening element on the wall of the inlet, this keeps the bag taut and open, further facilitating the bag filling operation. These holding elements also ensure that the bag does not slide down inside the container. The opening of the bag would be even greater if it is attached to three or even all four side walls of the container.

If desired, the side wall with the inlet mouth may comprise a second holding element for holding a bag.

According to a preferred implementation, the lid comprises two engageable flaps, and it can also comprise two reinforcing flaps that are placed below the engageable flaps. This reinforced lid system does not collapse due to a weight placed on it, either by stacking another container or by accidental support that would exert undistributed pressure and therefore would test the lid structural strength.

Preferably, the first holding element is defined in the side wall by a slot, from whose ends fold lines extend to the attached side walls.

The first holding element may also be formed by at least two ends of the material in substantially in contact before introducing the bag between them, so that when introducing it, the bag would be pinched between these at least two ends.

It may also be formed by a projection that would protrude through the upper part of the side wall in which it is located, or it may be located in the lower edge of an opening located in turn in the side wall.

Furthermore, if desired, in the waste container according to the present disclosure, two opposite side walls comprise stacking protrusions.

These stacking protrusions allow a more stable stacking avoiding movements between stacked containers, especially during use or handling. In addition, these stacking protrusions can be used as fastening elements for a bag by hanging from them the handles or the edge of the bag.

Advantageously, the sheet comprises a joining flap on one of the side walls to join its opposite side wall for mounting the container.

If desired, the inlet mouth can extend towards the top of the container, for example, in at least one of the engageable flaps or the reinforcement flaps of the lid, and two opposite side walls comprise respective handle-like holes.

Extending the inlet mouth towards the lid allows, on the one hand, to take it as far as possible to the upper end of the side wall, gaining a maximum opening and, on the other hand, to expand the mouth facilitating the entry of waste into those containers that do not have any container stacked on top.

According to a preferred implementation of the container according to the present disclosure, the bottom comprises a first sector provided with an oblique folding line that defines a first joining zone, and a second sector connected to the first sector in the first joining zone, and the bottom may also comprise a third sector provided with an oblique folding line defining a second joining zone, and a fourth sector joined to the third sector in the second joining zone.

Preferably, the sheet is of corrugated material, for example, of corrugated cardboard, with a plurality of channels parallel to each other, the channels being arranged vertically or obliquely on the side walls in their position of use.

With the waste container according to the present disclosure, at least the following advantages are achieved:
it allows its transport and storage completely flat when not in use, occupying a very small space;
its assembly is quick and easy;
it allows to comfortably place and remove the inner bag, accessing it easily through the inlet mouth;
thanks to its low cost, it is possible to discard the container after one use or few uses;
being made from a single piece, it is not essential to use a grouping element to be able to sell it unitarily at the point of sale, and it also represents an advantage in distribution and storage for the same reason; and
it allows stacking several containers one on top of the other, allowing easy access to the inlet mouth.

### BRIEF DESCRIPTION OF THE DRAWINGS

For better understanding of what has been disclosed, some drawings in which, schematically and only by way of a non-limiting example, practical examples of the disclosed waste container are shown.

FIG. 1 is a perspective view of the unfolded sheet that forms the waste container according to the present disclosure, according to a first example.

FIG. 2 is a perspective view of the waste container according to the present disclosure with its lid opened, according to the first example.

FIG. 3 is a perspective view of the waste container according to the present disclosure with its lid closed, according to the first example.

FIG. 4 is a perspective view of the waste container according to the present disclosure with its lid opened, according to a second example.

FIG. 5 is a perspective view of the waste container according to the present disclosure with its lid opened, according to a third example.

FIG. 6 is a perspective view of the waste container according to the present disclosure with its lid opened, according to a fourth example.

FIG. 7 is a perspective view of the waste container according to the present disclosure with its lid opened, according to a fifth example.

### DETAILED DESCRIPTION

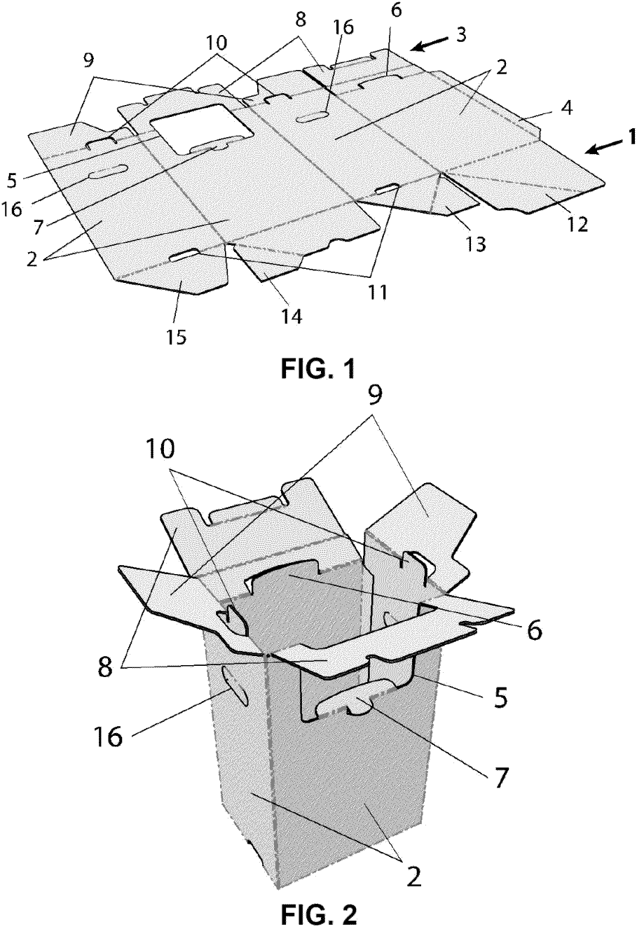

In FIG. 1, a sheet is show, from which the waste container according to the present disclosure is formed.

The sheet comprises a plurality of folding lines, which define a bottom 1, side walls 2 and a lid 3.

This sheet is made from a corrugated material, for example of corrugated cardboard, comprising a plurality of channels parallel to each other. In the position of use of the container, which is shown in the rest of the figures, the channels are arranged vertically or inclined on the side walls 2.

Furthermore, for the assembly of the sheet, it comprises a joining flap 4 on one of the side walls 2, to join its opposite side wall 2 for mounting the container.

One of the side walls 2 comprises an inlet mouth 5 for the introduction of waste into a bag (not shown) that is placed inside the container.

If desired, and as shown in this example, the inlet mouth can also partially extend into the lid 3.

To place the bag inside the container, it comprises a first holding element 6, for example, a flange, which holds the bag. This first holding element 6 is located on the side wall 2 opposite the side wall 2 in which the inlet is located, although it could be placed on one or more of any of the side walls 2, and preferably at a height greater than or equal to the height of the lower edge of the inlet 5.

According to the shown example, the first holding element 6 is defined in the side wall by a slot, from whose ends folding lines extend to the attached side walls.

In the example shown, it can be seen that there is a second holding element 7 to hold the bag, in this case, on the lower edge of the inlet mouth 5.

According to the shown example, the lid 3 comprises two engageable flaps 8 and two reinforcing flaps 9, placed below the engageable flaps 8 in the position of use with the lid 3 closed.

For their engagement, the engageable flaps 8 comprise at least one slot on their facing faces, and define a double thickness at least in the central part of the lid 3, which together with the reinforcing flaps 9 provide great resistance to the container when stacked one on top of the other.

For stacking, the container according to the present disclosure comprises at least two stacking protrusions 10, which are inserted into complementary slots 11 of a stacked container.

On the other hand, according to the shown example, the bottom 1 comprises a first sector 13 provided with an oblique folding line that defines a first joining zone, a second sector 12 connected to the first sector 13 in the first joining zone, a third sector 14 provided with an oblique folding line defining a second joining zone, and a fourth sector 15 joined to the third sector 14 in the second joining zone.

This type of bottom has the advantage that its folding and unfolding is carried out automatically when folding and unfolding the container, although it should be noted that the bottom could be any known bottom.

The container according to the present disclosure may also comprise handle-like holes 16 in two opposite side walls 2, to facilitate handling of the container in its assembled position.

From the position shown in FIG. 1, for mounting the container, firstly, it is necessary to attach the joining flap 4 to the opposite side wall 2. This attachment is made at the time of manufacture of the container, so that the container is provided to the user with the joining flap 4 attached to the side wall 2.

Subsequently, and also during its manufacturing process, the sectors of the bottom are joined, as mentioned previously.

Next, the box is formed to its parallelepipedic disposition, which, advantageously, can be done very comfortably thanks to the automatic unfolding of the bottom, leaving the box in the position shown in FIG. 2.

In this position, with the lid 3 opened, a bag (not shown) is inserted into the container and fastened to the first holding element 6 and, optionally, if present, to the second holding element 7.

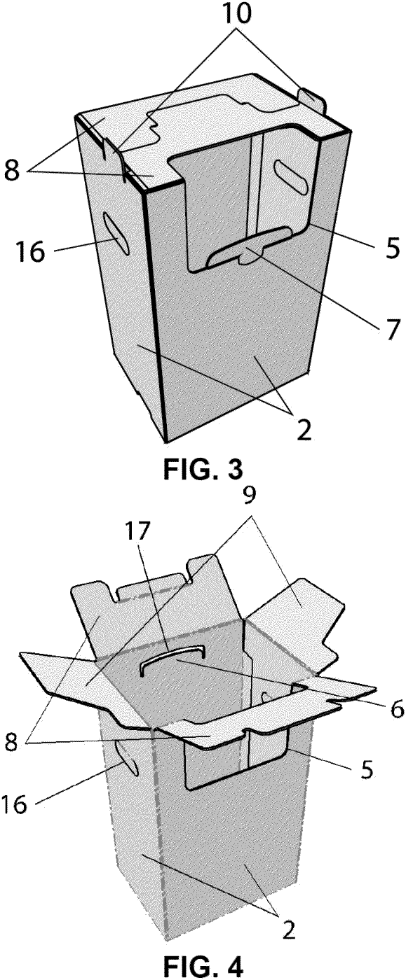

The lid 3 is then closed by first folding the reinforcing flaps 9 and subsequently coupling the engageable flaps 8 together, the container remaining in the position shown in FIG. 3, ready for use.

If desired, one or more containers of the same characteristics can be placed on this container, the stacking projections 10 being housed in the slots 11 of a stacked container.

For its use, the user simply deposits the waste inside the bag housed in the container, until the bag is full.

To remove the bag, the user has only to open the lid 3 and remove the bag from the holding elements 6, 7, being able to use the container one or more times.

In FIG. 4, a second example of the container according to the present disclosure is shown. For the sake of simplicity, only the differences from the first example are described.

Specifically, the main difference is that the bag is held by a single holding element 6, which is located at the bottom of an opening 17 located in the same side wall 2 that in the previous example, but it does not include any folding line that extend into the attached side walls.

Furthermore, in this second example, the stacking protrusions are not present, so that stacking can be performed simply by placing one container on top of another.

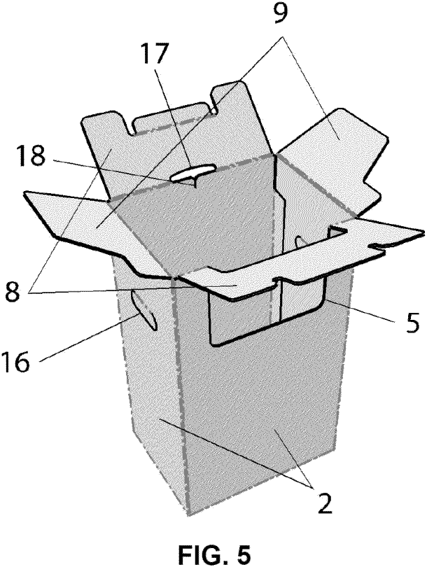

In FIG. 5, a third example of the container according to the present disclosure is shown. For the sake of simplicity, only the differences from the second example are described.

The main difference in this example is that the first holding element 6 of the bag is not a flange, but a slot provided with a perpendicular cut line, which allows the introduction of a fold of the bag between two edges of the material that are substantially in contact with each other before inserting the bag.

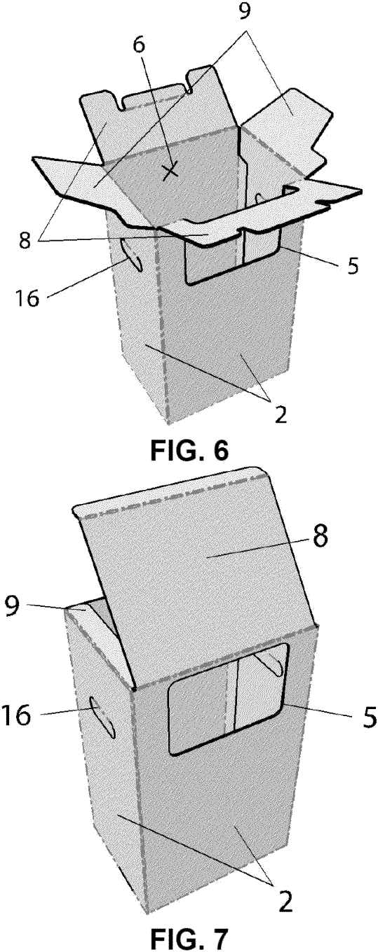

In FIG. 6, a fourth example of the container according to the present disclosure is shown. For the sake of simplicity, only the differences from the third example are described.

The main difference in this example is that the first holding element 6 of the bag are slots defined by a series of cuts, for example 2 cuts forming a cross, which allows the introduction of a fold of the bag between two or more edges of material that are substantially in contact with each other before inserting the bag.

In FIG. 7, a fifth example of the container according to the present disclosure is shown. For the sake of simplicity, only the differences from the previous example are described.

In this example, the lid 3 is formed by a single flap that covers the entire upper extension of the container and that includes a tab at its distal end to facilitate its closure. Furthermore, in this example, the reinforcing flaps 9 are shorter than in the previous examples.

Another difference is that the inlet mouth 5 does not extend towards the lid 3 but is arranged only on the side wall 2.

It should be noted that these differences from the second to fifth examples can also be included in the first example and can be interchanged in any of the examples. For example, in any of the examples the inlet mouth 5 may be provided only on the side wall 2, or the lid of the fifth example may be used in any of the first to fourth examples.

Although reference has been made to specific examples of the disclosure, it is apparent to a person skilled in the art that the described waste container is susceptible of numerous variations and modifications, and that all the details mentioned can be replaced by other technically equivalents, without departing from the scope of protection defined by the appended claims.

What is claimed is:

1. A waste container, comprising:
a foldable sheet provided with a plurality of folding lines, which, when folded to define the waste container, comprises:
a bottom;
side walls, including a first side wall and a second side wall;
a lid; and
a first holding element to hold a bag,
wherein the waste container defines an inlet mouth for introduction of waste into the waste container, the inlet mouth being arranged on the first side wall.

2. The waste container of claim 1, wherein the first holding element is arranged on the second side wall.

3. The waste container of claim 2, wherein the first side wall is opposite to the second side wall.

4. The waste container of claim 1, wherein the first holding element is arranged at a height equal to or greater than a height of a lower edge of the inlet mouth.

5. The waste container of claim 1, wherein the first side wall comprises a second holding element for holding the bag.

6. The waste container of claim 1, wherein the lid comprises two engageable flaps.

7. The waste container of claim 6, wherein the inlet mouth extends onto at least one of the engageable flaps.

8. The waste container of claim 6, wherein the lid further comprises two reinforcing flaps arrangeable underneath the engageable flaps.

9. The waste container of claim 8, wherein the inlet mouth extends onto at least one of the reinforcing flaps.

10. The waste container of claim 1, wherein the first holding element is defined on the second side wall by at least one slot.

11. The waste container of claim 1, wherein the first holding element is defined on the second side wall by a projection that protrudes through an upper part of the second side wall or is located on a lower edge of an opening located on the second side wall.

12. The waste container of claim 1, wherein the first holding element is defined by two or more edges of the foldable sheet that are in contact with or next to each other.

13. The waste container of claim 1, wherein the side walls further include third and fourth side walls arranged opposite to each other, the waste container further comprising first and second stacking projections that respectively extend from the third and fourth side walls.

14. The waste container of claim 1, wherein the foldable sheet comprises a joining flap on one of the side walls to join together two of the side walls.

15. The waste container of claim 1, wherein the bottom comprises:
a first sector provided with an oblique folding line defining a first joining zone;
a second sector attached to the first sector in the first joining zone;
a third sector provided with an oblique folding line defining a second joining zone; and
a fourth sector connected to the third sector in the second joining zone.

16. The waste container of claim 1, wherein the foldable sheet comprises a corrugated material with a plurality of channels parallel to each other, the channels being arranged vertically or obliquely on the side walls when the bottom is disposed on a horizontal surface.
